(19) United States
(12) Patent Application Publication
(10) Pub. No.: US 2018/0239848 A1
(43) Pub. Date: Aug. 23, 2018

(54) Numerical Blast Simulation Methods and Systems Thereof

(71) Applicant: Livermore Software Technology Corporation, Livermore, CA (US)

(72) Inventor: Hailong Teng, Livermore, CA (US)

(21) Appl. No.: 15/437,769

(22) Filed: Feb. 21, 2017

(51) Int. Cl. G06F 17/50; G06F 17/16; G06F 17/11

(52) U.S. Cl. CPC G06F 17/5009; G06F 2217/16; G06F 17/11; G06F 17/16

(57) ABSTRACT

Numerical blast simulation methods and systems are disclosed. SPH model containing a plurality of SPH particles representing a physical domain is received. Each SPH particle is associated with an influence function having a domain of influence. Blast source model containing at least one simulated gas particle is created. The blast source model, defined by a set of explosion characteristics, represents the explosion just before impacting the physical domain. Each simulated gas particle is associated with a set of properties that includes a mass, a velocity vector and a location. Numerically calculated domain behaviors in response to the explosion are obtained by conducting a time-marching simulation for a predetermined duration in a plurality of solution cycles using the SPH model and the blast source model, the domain behaviors are a result of combined interactions between said each simulated gas particle and a corresponding subgroup of the SPH particles.

### FIELD

The invention generally relates to computer aided mechanical engineering analysis, more particularly to methods and systems for performing time-marching simulation of a physical domain in response to an explosion using a combination of simulated gas particles representing the blast source and smoothed-particle hydrodynamics (SPH)) particles representing the physical domain.

### BACKGROUND

Continuum mechanics has been used for simulating continuous matter such as solids and fluids (i.e., liquids and gases). Differential equations are employed in solving problems in continuum mechanics. Many numerical procedures have been used, including but not limited to, finite element method (FEM), meshfree methods such as discrete element method (DEM), Smoothed-particle Hydrodynamics (SPH), and etc.

There are limitations/drawbacks to these numerical procedures for numerically simulating a continuum physical domain in response to an explosion. For example, FEM requires a mesh that would result to numerical singularity (i.e., unsolvable numerical problem) when the physical domain experienced a large deformation, DEM is more suitable for objects that are not tightly coupled (e.g., sands), while SPH suffers difficulty of imposing boundary conditions.

Therefore, it would be desirable to have improved methods that can more realistically conduct a numerical simulation of a physical domain in response to an explosion.

### SUMMARY

This section is for the purpose of summarizing some aspects of the invention and to briefly introduce some preferred embodiments. Simplifications or omissions in this section as well as in the abstract and the title herein may be made to avoid obscuring the purpose of the section. Such simplifications or omissions are not intended to limit the scope of the invention.

Numerical blast simulation methods and systems are disclosed. According to one aspect of the invention, a method of obtaining numerically simulated behaviors of a physical domain in response to an explosion. The method comprises the following: a smoothed-particle method (SPH) model containing a plurality of SPH particles representing a physical domain is received in a computer system having at least one application module installed thereon. Each SPH particle is associated with an influence function having a domain of influence. Using the application module, a blast source model containing a group of at least one simulated gas particle is created. The blast source model, defined by a set of explosion characteristics, represents the explosion just before impacting the physical domain. Each simulated gas particle is associated with a set of properties that includes a mass, a velocity vector and a location. Numerically calculated domain behaviors in response to the explosion are obtained by conducting a time-marching simulation for a predetermined duration in a plurality of solution cycles using the SPH model and the blast source model, the domain behaviors are a result of combined interactions between said each simulated gas particle and a corresponding subgroup of the SPH particles.

According to another aspect, the result of combined interactions are computed as follows: (a) determining which of the SPH particles to be included in the corresponding subgroup for each simulated gas particle based on a subgroup determination rule; (b) calculating a representative location of the subgroup using a formula algebraically combining respective properties of those SPH particles determined to be included in the subgroup; (c) performing numerical energy exchange between said each simulated gas particle and the subgroup based on a set of energy exchange rules; and (d) updating the set of properties of said each simulated gas particle and respective locations of the SPH particles from the numerical energy exchange for next solution cycle.

Other objects, features, and advantages of the invention will become apparent upon examining the following detailed description of an embodiment thereof, taken in conjunction with the attached drawings.

### BRIEF DESCRIPTION OF THE DRAWINGS

These and other features, aspects, and advantages of the invention will be better understood with regard to the following description, appended claims, and accompanying drawings as follows:

FIGS. 1A-1B collectively show a flowchart illustrating an example process of obtaining a numerical a physical domain in response to an explosion, according to an embodiment of the invention;

FIG. 2A is a diagram showing an example physical domain represented by a number of SPH particles in accordance with an embodiment of the invention;

FIG. 2B is a diagram showing an example influence function used in SPH method, according to an embodiment of the invention;

FIGS. 3A-3B are diagrams showing two different example physical domains, according to an embodiment of the invention;

FIG. 4 is a diagram depicting a group of at least one simulated gas particle that represents an example blast source before impacting a physical domain of interest, according to an embodiment of the invention;

FIGS. 5A-5D are diagrams illustrating an interaction between an example simulated gas particle and a corresponding subgroup of the SPH particles in accordance with one embodiment of the invention;

FIG. 6 is a function diagram showing salient components of a computing device, in which an embodiment of the invention may be implemented; and

FIGS. 7A-7C are diagrams showing three snapshots results of an example numerical blast simulation in time, according to an embodiment of the invention.

### DETAILED DESCRIPTION

In the following description, numerous specific details are set forth in order to provide a thorough understanding of the invention. However, it will become obvious to those skilled in the art that the invention may be practiced without these specific details. The descriptions and representations herein are the common means used by those experienced or skilled in the art to most effectively convey the substance of their work to others skilled in the art. In other instances, well-known methods, procedures, components, and circuitry have not been described in detail to avoid unnecessarily obscuring aspects of the invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

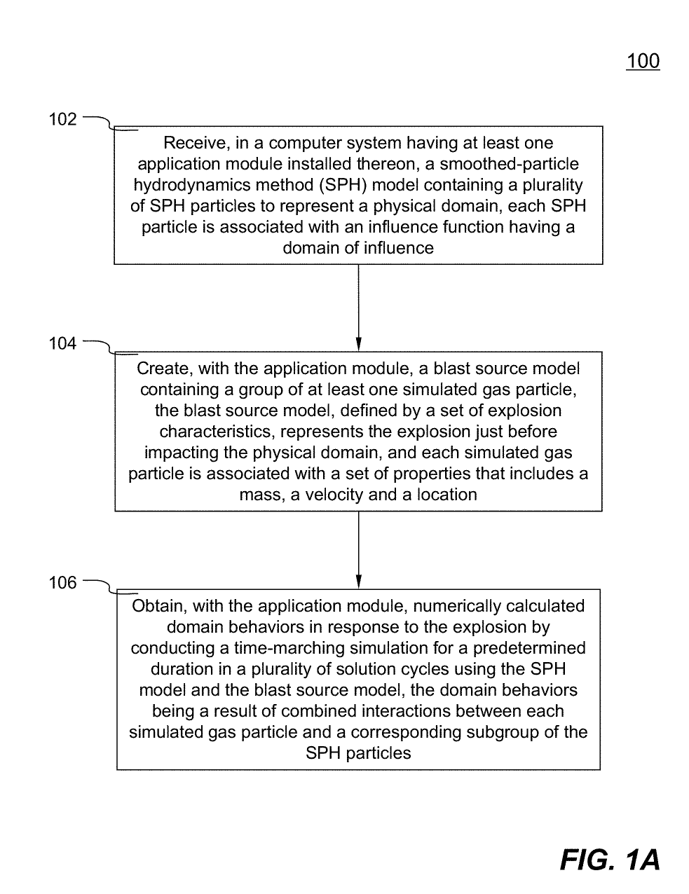

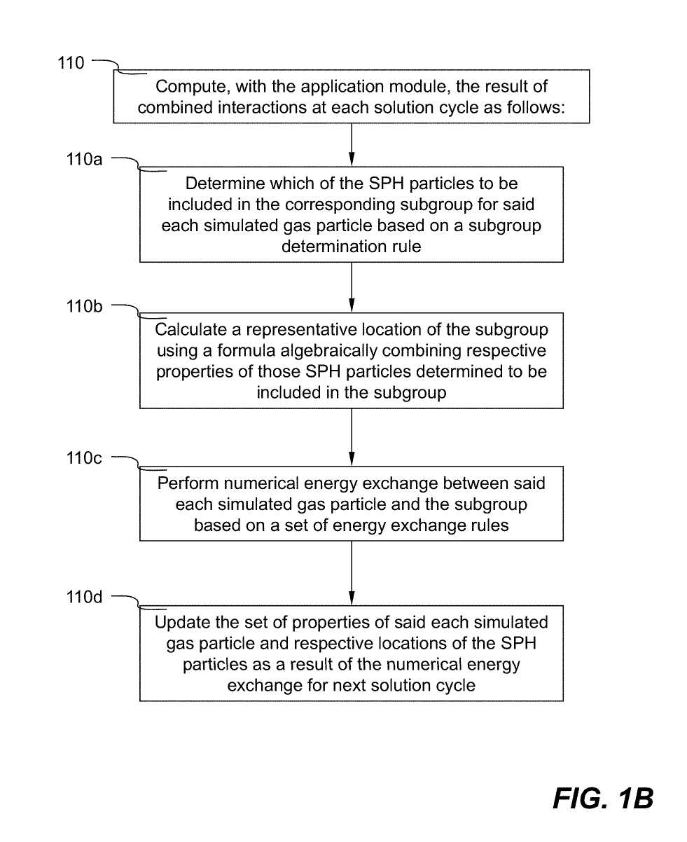

Embodiments of the invention are discussed herein with reference to FIGS. 1A-7C. However, those skilled in the art will readily appreciate that the detailed description given herein with respect to these figures is for explanatory purposes as the invention extends beyond these limited embodiments.

Referring first to FIGS. 1A-1B, it is collectively shown a flowchart illustrating an example process 100 of obtaining numerically simulated behaviors of a physical domain in response to an explosion, according to an embodiment of the invention. Process 100 is preferably implemented in software.

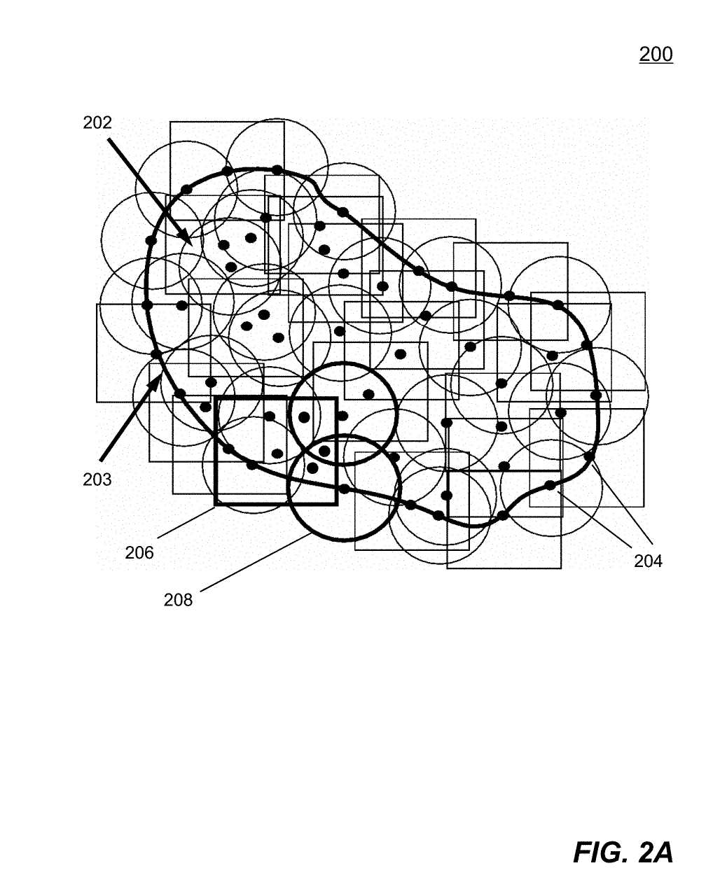

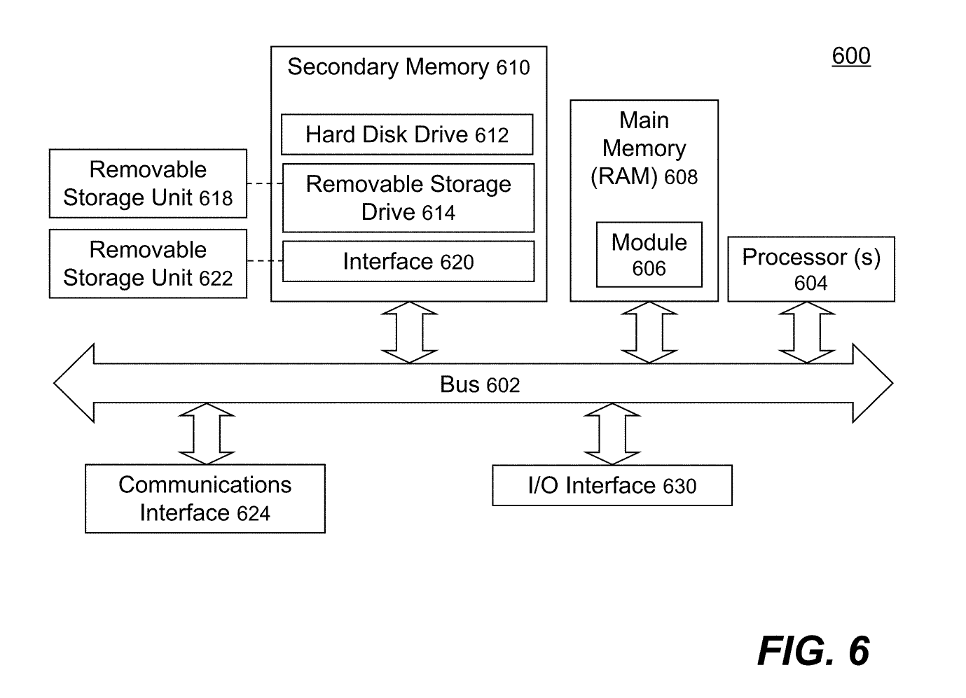

Process 100 starts by receiving a smoothed-particle hydrodynamics method (SPH) model representing a physical domain (e.g., a structure) in a computer system (e.g., computer system 600 of FIG. 6) having at least one application module installed thereon at action 102. FIG. 2A shows an example physical domain 202 having a boundary or border 203. To represent the physical domain 202, an SPH model 200 containing a plurality of SPH particles 204 is used. SPH particles 204 representing physical domain 202 do not have a particular pattern. They may be regularly spaced or in random locations. These SPH particles 204 may be located in the interior 202 or on the boundary 203 of the physical domain. Each SPH particle 204 is associated with an influence function (e.g., mesh-free shape function 240 FIG. 2B) which has a domain of influence or support 206, 208. The size and the shape of a support or domain of influence for each node are arbitrary. In one embodiment, the shape of the support is quadrilateral 206. In another embodiment, the shape is circular 208. In the case of three-dimensional support, the shape of the support may be spherical in that embodiment. In yet another embodiment, the size and the shape of each node are different. One node may have a one square foot support while another node may have a 16-in radius circular support in the same model. In yet another embodiment, the support is not a regular geometric shape. It can be any arbitrary shape. The invention supports different combinations.

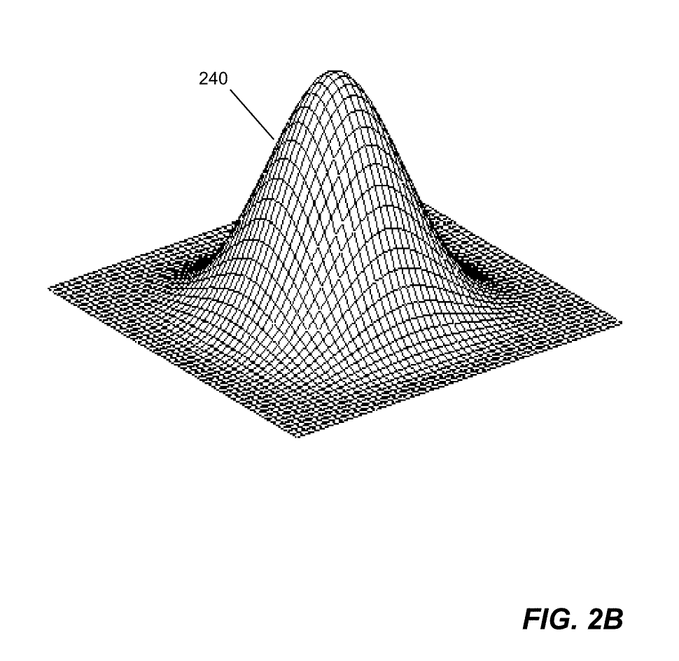

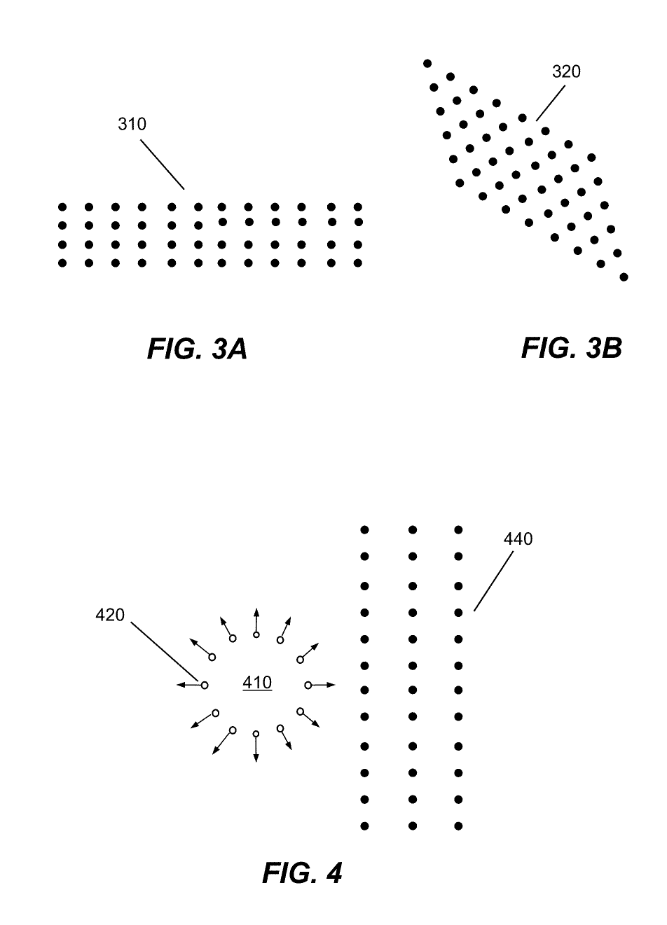

Two other example SPH models 310-320 are shown in FIGS. 3A-3B. For illustration simplicity, both SPH models 310-320 are two-dimensional. For those having ordinary skill in the art would know that the SPH models can also be three-dimensional.

Next, at action 104, process 100 using the application module creates a blast source model, which contains a group of at least one simulated gas particle. Each simulated gas particle is associated with a set of properties that includes a mass, a velocity vector and a location. As shown in FIG. 4, an example blast source model 410 contains a number of simulated gas particles 420 (i.e., location and mass (shown as a small circle), and velocity vector (shown as an arrow)). It is noted that simulated gas particle does not have a volume. Velocity vector may contain both translational and rotational velocity. Blast source model 410, defined by a set of explosion characteristics, represents the explosion just before impacting the physical domain 440 of interest. Simulated gas particles only interact with other particles when they collide, while the SPH particles influence other particles through influence function. Explosion characteristics may include, but are not limited to, the strength of the blast, the shape of the charge, etc. In one embodiment, the strength of the blast is specified by types (e.g., TNT, C-4, etc.). In another embodiment, properties of the explosive are specified by user. As for the shape of the charge, it can be any given geometric shape, for example, circle in two-dimension, or sphere or cylinder in three-dimension. Further, in another embodiment, the shape and the number of simulated gas particles of a blast source model is specified by user.

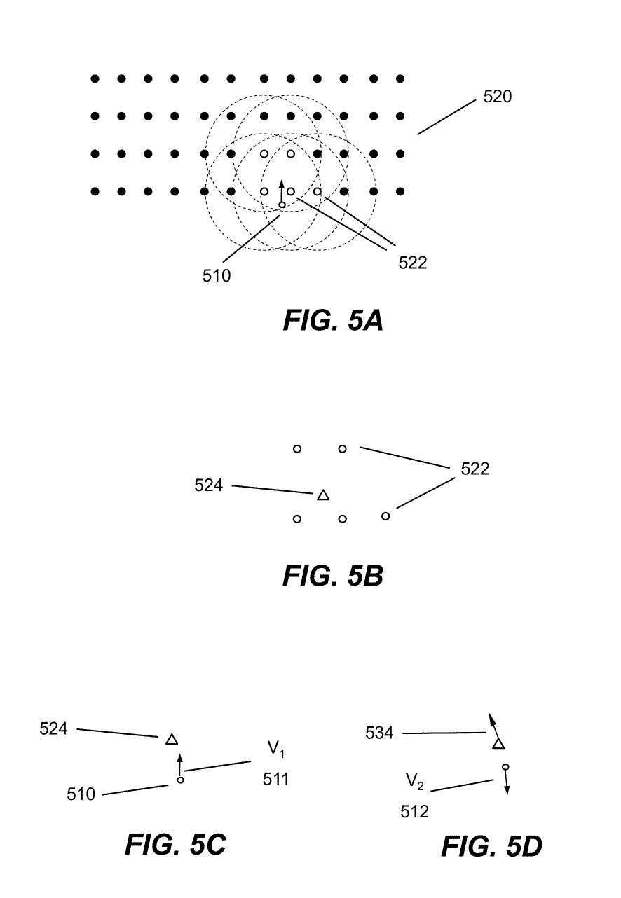

Then, at action 106, the numerically calculated domain behaviors are obtained by conducting a time-marching simulation for a predetermined duration (i.e., total simulation time) using the SPH model represent the physical domain and the blast source model representing the explosion. The time-marching simulation contains a number of solution cycles each representing a snapshot in time within the predetermined duration. Time-marching simulation can be achieved with either implicit or explicit solution scheme. The behaviors of the physical domain are a result of combined interactions between each simulated gas particle and a corresponding subgroup of the SPH particles. The flowchart in FIG. 1B summarizes an example procedure 110 for computing the combined interactions at each solution cycle. At action 110a, a corresponding subgroup of the SPH particles is determined for each simulated gas particle based on a subgroup determination rule. For example, a corresponding subgroup of the SPH particles is determined by including those SPH particles whose domain of influence encompasses the location of a particular simulated gas particle. FIG. 5A shows an example simulated gas particle 510 moves into a physical domain 520. Five SPH particles 522 (i.e., hollowed dots) is determined to be included in a subgroup because the location of the simulated gas particle 510 is within respective domains of influence (dotted circles) of these five SPH particles 522. Other rules may be used to accomplish the same, for example, a predefined distance between each simulated gas particle and a corresponding SPH particle.

Next, at action 110b, procedure 110 calculates a representative location of the subgroup using a formula algebraically combining respective properties of those SPH particles determined to be included in the subgroup. The formula can employ a number of known schemes, for example, simply average, weighted average, etc. In one embodiment, the representative location is the geometric centroid of the subgroup. For example, FIG. 5B shows the geometric centroid 524 (i.e., shown as a triangle) of the subgroup of five SPH particles (hollowed dots).

Then, at action 110c, numerical energy exchange between the simulated gas particle 510 and the subgroup 524 is performed in accordance with a set of energy exchange rules. For example, the energy exchange rules are based on the energy conservation principles. FIG. 5C shows an example simulated gas particle 510 having a first velocity vector V₁ 511 collided with the corresponding subgroup 524. In one embodiment, respective subgroups of SPH particles for two different simulated gas particles may contain entirely different SPH particles. In another embodiment, the respective subgroups may contain some or all of the same SPH particles therein.

At action 110d shown in FIG. 5D, the properties (i.e., location and velocity vector) of the simulated gas particle 510 and the location of the SPH particles 522 in the subgroup 524 are updated after the energy exchange for next solution cycle. The updated location of the SPH particles (i.e., physical domain behaviors in response to the explosion) are based on the resultant force of the collision between each simulated gas particle and the corresponding subgroup of the SPH particles. One example of the numerical energy exchange is to assume that the subgroup of the SPH particles has much larger mass than that of a simulated gas particle. Therefore, the resultant force after the numerical energy exchange is the mass of the simulated gas particle multiplied by the velocity differences before and after the collision. Velocity difference may include translational and/or rotational velocity. In other words, the location and second velocity vector V₂ 512 of the simulated gas particle are updated as a result of the energy exchange. Respective locations of the SPH particles 522 in the subgroup 524 are calculated using SPH influence function in response to the resultant force 534. In one embodiment, resultant force=m (V₂−V₁), where m is the mass of the simulated gas particle. Procedure 110 is for each and every simulated gas particle in the blast source model. The updated properties of the SPH particles affect other SPH particles located within the domain of influence via the influence function.

Moreover, the scenario shown in FIGS. 5A-5B is only one example of obtaining domain behaviors in accordance with an embodiment of the invention. Other scenarios such as different patterns and/or numbers of SPH particles can occur in other embodiments. Coupling of simulated gas particle and the SPH particles achieves a more realistic numerical blast simulation according to an embodiment of the invention.

According to one aspect, the invention is directed towards one or more computer systems capable of carrying out the functionality described herein. An example of a computer system 600 is shown in FIG. 6. The computer system 600 includes one or more processors, such as processor 604. The processor 604 is connected to a computer system internal communication bus 602. Various software embodiments are described in terms of this exemplary computer system. After reading this description, it will become apparent to a person skilled in the relevant art(s) how to implement the invention using other computer systems and/or computer architectures.

Computer system 600 also includes a main memory 608, preferably random access memory (RAM), and may also include a secondary memory 610. The secondary memory 610 may include, for example, one or more hard disk drives 612 and/or one or more removable storage drives 614, representing a floppy disk drive, a magnetic tape drive, an optical disk drive, etc. The removable storage drive 614 reads from and/or writes to a removable storage unit 618 in a well-known manner. Removable storage unit 618, represents a floppy disk, magnetic tape, optical disk, etc. which is read by and written to by removable storage drive 614. As will be appreciated, the removable storage unit 618 includes a computer usable storage medium having stored therein computer software and/or data.

In alternative embodiments, secondary memory 610 may include other similar means for allowing computer programs or other instructions to be loaded into computer system 600. Such means may include, for example, a removable storage unit 622 and an interface 620. Examples of such may include a program cartridge and cartridge interface (such as that found in video game devices), a removable memory chip (such as an Erasable Programmable Read-Only Memory (EPROM), Universal Serial Bus (USB) flash memory, or PROM) and associated socket, and other removable storage units 622 and interfaces 620 which allow software and data to be transferred from the removable storage unit 622 to computer system 600. In general, Computer system 600 is controlled and coordinated by operating system (OS) software, which performs tasks such as process scheduling, memory management, networking and I/O services.

There may also be a communications interface 624 connecting to the bus 602. Communications interface 624 allows software and data to be transferred between computer system 600 and external devices. Examples of communications interface 624 may include a modem, a network interface (such as an Ethernet card), a communications port, a Personal Computer Memory Card International Association (PCMCIA) slot and card, etc. Software and data transferred via communications interface 624. The computer 600 communicates with other computing devices over a data network based on a special set of rules (i.e., a protocol). One of the common protocols is TCP/IP (Transmission Control Protocol/Internet Protocol) commonly used in the Internet. In general, the communication interface 624 manages the assembling of a data file into smaller packets that are transmitted over the data network or reassembles received packets into the original data file. In addition, the communication interface 624 handles the address part of each packet so that it gets to the right destination or intercepts packets destined for the computer 600. In this document, the terms “computer program medium”, “computer readable medium”, “computer recordable medium” and “computer usable medium” are used to generally refer to media such as removable storage drive 614 (e.g., flash storage drive), and/or a hard disk installed in hard disk drive 612. These computer program products are means for providing software to computer system 600. The invention is directed to such computer program products.

The computer system 600 may also include an input/output (I/O) interface 630, which provides the computer system 600 to access monitor, keyboard, mouse, printer, scanner, plotter, and alike.

Computer programs (also called computer control logic) are stored as application modules 606 in main memory 608 and/or secondary memory 610. Computer programs may also be received via communications interface 624. Such computer programs, when executed, enable the computer system 600 to perform the features of the invention as discussed herein. In particular, the computer programs, when executed, enable the processor 604 to perform features of the invention. Accordingly, such computer programs represent controllers of the computer system 600.

In an embodiment where the invention is implemented using software, the software may be stored in a computer program product and loaded into computer system 600 using removable storage drive 614, hard drive 612, or communications interface 624. The application module 606, when executed by the processor 604, causes the processor 604 to perform the functions of the invention as described herein.

The main memory 608 may be loaded with one or more application modules 606 that can be executed by one or more processors 604 with or without a user input through the I/O interface 630 to achieve desired tasks. In operation, when at least one processor 604 executes one of the application modules 606, the results are computed and stored in the secondary memory 610 (i.e., hard disk drive 612). The status of the analysis is reported to the user via the I/O interface 630 either in a text or in a graphical representation upon user's instructions.

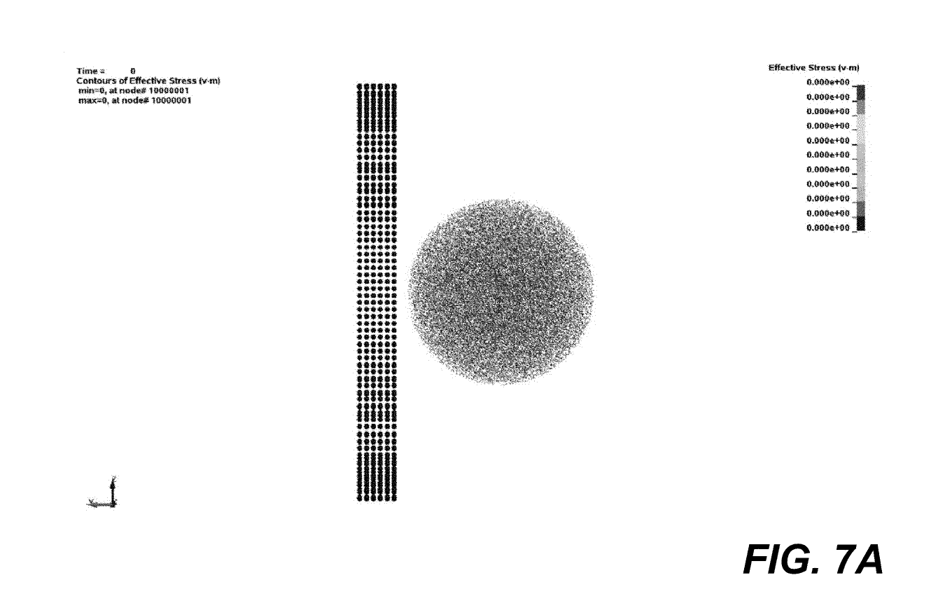

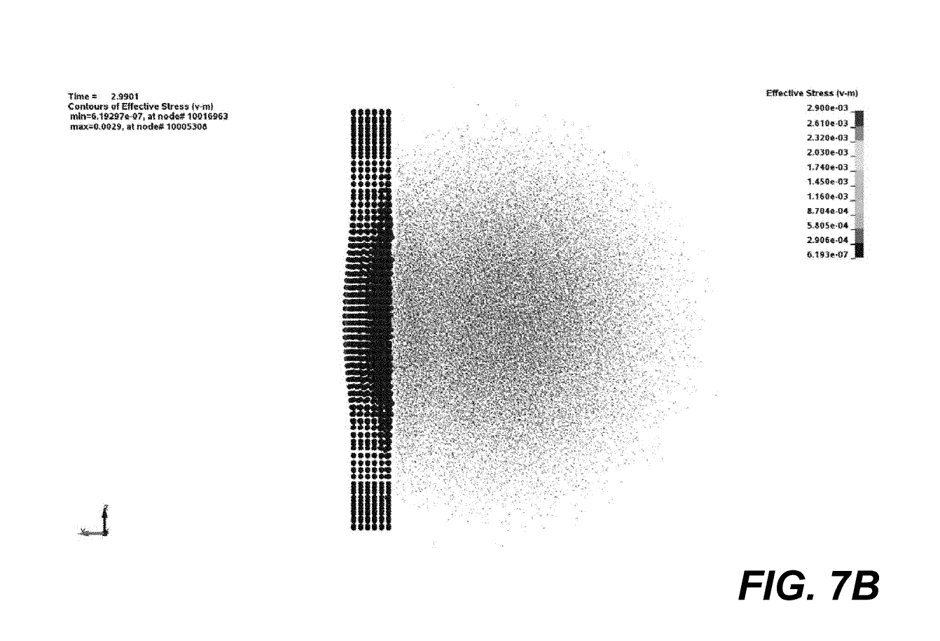

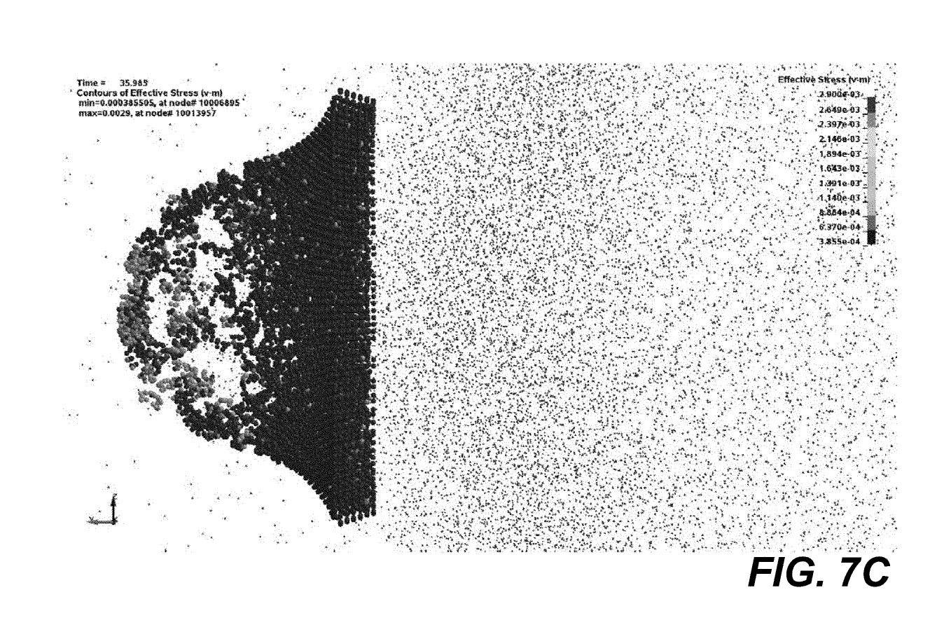

FIGS. 7A-7C are diagrams showing three graphical results of an example numerical blast simulation (i.e., three snapshots in time). The first snapshot is an initial configuration before the explosion impacting physical domain shown in FIG. 7A. The second snapshot shown in FIG. 7B is the explosion starts penetrating the physical domain, while the third snapshot (FIG. 7C) shows the physical domain deforms in response to the explosion.

Although the invention has been described with reference to specific embodiments thereof, these embodiments are merely illustrative, and not restrictive of, the invention. Various modifications or changes to the specifically disclosed exemplary embodiments will be suggested to persons skilled in the art. For example, whereas the example blast source model and the physical domain have been shown and described in two-dimensional space, the blast source model and the physical domain can be in three-dimensional space for the invention. In summary, the scope of the invention should not be restricted to the specific exemplary embodiments disclosed herein, and all modifications that are readily suggested to those of ordinary skill in the art should be included within the spirit and purview of this application and scope of the appended claims.

1. A method of obtaining numerically simulated behaviors of a physical domain in response to an explosion, the method comprising:
receiving, in a computer system having at least one application module installed thereon, a smoothed-particle hydrodynamics method (SPH) model containing a plurality of SPH particles to represent a physical domain, each SPH particle being associated with an influence function having a domain of influence;
creating, with the application module, a blast source model containing a group of at least one simulated gas particle, the blast source model representing the explosion just before impacting the physical domain and the blast source model being defined by a set of explosion characteristics, and each simulated gas particle being associated with a set of properties that includes a mass, a velocity vector and a location; and
obtaining, with the application module, numerically calculated domain behaviors in response to the explosion by conducting a time-marching simulation for a predetermined duration in a plurality of solution cycles using the SPH model and the blast source model, the domain behaviors being a result of combined interactions between said each simulated gas particle and a corresponding subgroup of the SPH particles, at each solution cycle, computing the result of combined interactions as follows:
determining which of the SPH particles to be included in the corresponding subgroup for said each simulated gas particle based on a subgroup determination rule;
calculating a representative location of the subgroup using a formula algebraically combining respective properties of those SPH particles determined to be included in the subgroup;
performing numerical energy exchange between said each simulated gas particle and the subgroup based on a set of energy exchange rules; and
updating the set of properties of said each simulated gas particle and respective locations of the SPH particles from the numerical energy exchange for next solution cycle.

2. The method of claim 1, wherein the subgroup determination rule is based on the location of said each simulated gas particle and the domain of influence of each of the SPH particles.

3. The method of claim 2, wherein the subgroup determination rule is to include said those SPH particles whose the domain of influence encompasses the location of said each simulated gas particle.

4. The method of claim 1, wherein the set of energy exchange rules is based on energy conservation principles.

5. The method of claim 1, wherein the respective locations of the SPH particles are updated from a resultant force from each numerical energy exchange.

6. The method of claim 5, wherein the resultant force is calculated using a formula:
F=m(V₂−V₁), where F is the resultant force, m is the mass, V₂ is the velocity vector after said each numerical energy exchange and V₁ is the velocity vector before said each numerical energy exchange of said each simulated gas particle.

7. The method of claim 6, wherein the numerically calculated domain behaviors are a combination of all of the numerical energy exchanges between said each simulated gas particle and the corresponding subgroup.

8. The method of claim 1, wherein the set of explosion characteristics comprises a geometric shape of the blast source and a explosive type.

9. A system for obtaining numerically simulated behaviors of a physical domain in response to an explosion, the system comprising;
a memory for storing computer readable code for at least one application module;
at least one processor coupled to the memory, said at least one processor executing the computer readable code in the memory to cause the application module to perform operations of:
receiving a smoothed-particle hydrodynamics method (SPH) model containing a plurality of SPH particles to represent a physical domain, each SPH particle being associated with an influence function having a domain of influence;
creating a blast source model containing a group of at least one simulated gas particle, the blast source model representing the explosion just before impacting the physical domain and the blast source model being defined by a set of explosion characteristics, and each simulated gas particle being associated with a set of properties that includes a mass, a velocity vector and a location; and
obtaining numerically calculated domain behaviors in response to the explosion by conducting a time-marching simulation for a predetermined duration in a plurality of solution cycles using the SPH model and the blast source model, the domain behaviors being a result of combined interactions between said each simulated gas particle and a corresponding subgroup of the SPH particles, at each solution cycle, computing the result of combined interactions as follows:
determining which of the SPH particles to be included in the corresponding subgroup for said each simulated gas particle based on a subgroup determination rule;
calculating a representative location of the subgroup using a formula algebraically combining respective properties of those SPH particles determined to be included in the subgroup;
performing numerical energy exchange between said each simulated gas particle and the subgroup based on a set of energy exchange rules; and
updating the set of properties of said each simulated gas particle and respective locations of the SPH particles from the numerical energy exchange for next solution cycle.

10. The system of claim 9, wherein the subgroup determination rule is based on the location of said each simulated gas particle and the domain of influence of each of the SPH particles.

11. The system of claim 10, wherein the subgroup determination rule is to include said those SPH particles whose the domain of influence encompasses the location of said each simulated gas particle.

12. The system of claim 9, wherein the respective locations of the SPH particles are updated from a resultant force from each numerical energy exchange.

13. The system of claim 12, wherein the resultant force is calculated using a formula:
F=m(V₂−V₁), where F is the resultant force, m is the mass, V₂ is the velocity vector after said each numerical energy exchange and V₁ is the velocity vector before said each numerical energy exchange of said each simulated gas particle.

14. The system of claim 13, wherein the numerically calculated domain behaviors are a combination of all of the numerical energy exchanges between said each simulated gas particle and the corresponding subgroup.

15. A non-transitory computer readable medium containing instructions for obtaining numerically simulated behaviors of a physical domain in response to an explosion by a method comprising:
receiving, in a computer system having at least one application module installed thereon, a smoothed-particle hydrodynamics method (SPH) model containing a plurality of SPH particles to represent a physical domain, each SPH particle being associated with an influence function having a domain of influence;
creating, with the application module, a blast source model containing a group of at least one simulated gas particle, the blast source model representing the explosion just before impacting the physical domain and the blast source model being defined by a set of explosion characteristics, and each simulated gas particle being associated with a set of properties that includes a mass, a velocity vector and a location; and
obtaining, with the application module, numerically calculated domain behaviors in response to the explosion by conducting a time-marching simulation for a predetermined duration in a plurality of solution cycles using the SPH model and the blast source model, the domain behaviors being a result of combined interactions between said each simulated gas particle and a corresponding subgroup of the SPH particles, at each solution cycle, computing the result of combined interactions as follows:
determining which of the SPH particles to be included in the corresponding subgroup for said each simulated gas particle based on a subgroup determination rule;
calculating a representative location of the subgroup using a formula algebraically combining respective properties of those SPH particles determined to be included in the subgroup;
performing numerical energy exchange between said each simulated gas particle and the subgroup based on a set of energy exchange rules; and
updating the set of properties of said each simulated gas particle and respective locations of the SPH particles from the numerical energy exchange for next solution cycle.

16. The non-transitory computer readable medium of claim 15, wherein the subgroup determination rule is based on the location of said each simulated gas particle and the domain of influence of each of the SPH particles.

17. The non-transitory computer readable medium of claim 16, wherein the subgroup determination rule is to include said those SPH particles whose the domain of influence encompasses the location of said each simulated gas particle.

18. The non-transitory computer readable medium of claim 15, wherein the respective locations of the SPH particles are updated from a resultant force from each numerical energy exchange.

19. The non-transitory computer readable medium of claim 18, wherein the resultant force is calculated using a formula: F=m(V₂−V₁), where F is the resultant force, m is the mass, V₂ is the velocity vector after said each numerical energy exchange and V₁ is the velocity vector before said each numerical energy exchange of said each simulated gas particle.

20. The non-transitory computer readable medium of claim 19, wherein the numerically calculated domain behaviors are a combination of all of the numerical energy exchanges between said each simulated gas particle and the corresponding subgroup.
